(19) United States
(12) Patent Application Publication
(10) Pub. No.: US 2025/0028219 A1
(43) Pub. Date: Jan. 23, 2025

(54) METHOD AND APPARATUS OF PERFORMING SPATIAL DOMAIN-BASED OPTICAL CONVOLUTION OPERATION

(71) Applicant: ELECTRONICS AND TELECOMMUNICATIONS RESEARCH INSTITUTE, Daejeon (KR)

(72) Inventors: Jin Hwa GENE, Daejeon (KR); Sun Tak PARK, Daejeon (KR); Jong Moo SOHN, Daejeon (KR); Hyung Cheol SHIN, Daejeon (KR)

(21) Appl. No.: 18/763,835

(22) Filed: Jul. 3, 2024

(30) Foreign Application Priority Data
Jul. 21, 2023 (KR) 10-2023-0095469
Mar. 26, 2024 (KR) 10-2024-0041202

(51) Int. Cl. G02F 1/29; G02B 27/46

(52) U.S. Cl. CPC G02F 1/293; G02B 27/46; G02F 1/294; G02F 2203/12

(57) ABSTRACT

The present disclosure relates to a method and apparatus for performing a spatial domain-based optical convolution operation. A method of performing a convolution operation according to an embodiment of the present disclosure may comprise: performing a first optical Fourier transform on a spatial domain image; performing a second optical Fourier transform on a spatial domain kernel; performing an element-wise product operation between a result of the first optical Fourier transform and a result of the second optical Fourier transform; calculating a convolution result by performing a third optical Fourier transform on a result of the element-wise product operation; and obtaining data based on the convolution result.

### CROSS-REFERENCE TO RELATED APPLICATIONS

This application claims the benefit of earlier filing date and right of priority to Korean Application No. 10-2023-0095469, filed on Jul. 21, 2023 and Korean Application No. 10-2024-0041202, filed on Mar. 26, 2024, the contents of which are all hereby incorporated by reference herein in their entirety.

### TECHNICAL FIELD

The present disclosure relates to an optical system for implementing a convolutional optical artificial neural network, and to a method and apparatus for performing a convolution operation of a spatial domain kernel and a spatial image.

### BACKGROUND

A convolutional artificial neural network is one of the feed-forward artificial neural network structures that shows high accuracy in image classification and inference. Convolutional artificial neural networks are widely used in fields that require image information processing, such as autonomous driving and the Internet of Things. With the development of wireless communication technology, its utilization is increasing. Accordingly, the amount of information processing required is increasing exponentially due to the ever-increasing number of training images and more sophisticated image information. However, the image information processing speed of existing electronic computers is slow in developing energy efficiency and calculation speed compared to the increasing amount of information, and is approaching its limit. Accordingly, the demand for computing systems with high processing speed and high energy efficiency is increasing.

A convolutional artificial neural network is composed of a combination of a convolution layer, a pooling layer, a fully connected layer, an activation layer, etc. Since the convolution layer, where convolution operations are performed, among these, accounts for a high proportion of the energy consumption of the artificial neural network, research is actively underway to increase energy efficiency and calculation speed by replacing convolution calculations performed by electronic computers with optical convolution calculation devices.

### SUMMARY

The technical object of the present disclosure is to provide a method and apparatus for performing spatial domain-based optical convolution calculation.

The technical object of the present disclosure is to provide a method and apparatus for optically performing a convolution operation of a spatial domain image and a spatial domain kernel by optically Fourier transforming the spatial domain kernel and performing element product operation using an opto-optical modulator.

The technical objects to be achieved by the present disclosure are not limited to the above-described technical objects, and other technical objects which are not described herein will be clearly understood by those skilled in the pertinent art from the following description.

A method of performing a convolution operation according to an aspect of the present disclosure may comprise: performing a first optical Fourier transform on a spatial domain image; performing a second optical Fourier transform on a spatial domain kernel; performing an element-wise product operation between a result of the first optical Fourier transform and a result of the second optical Fourier transform; calculating a convolution result by performing a third optical Fourier transform on a result of the element-wise product operation; and obtaining data based on the convolution result.

An apparatus for performing wireless charging according to an additional aspect of the present disclosure may comprise a processor and a memory, and the processor may be configured to: perform a first optical Fourier transform on a spatial domain image; perform a second optical Fourier transform on a spatial domain kernel; perform an element-wise product operation between a result of the first optical Fourier transform and a result of the second optical Fourier transform; calculate a convolution result by performing a third optical Fourier transform on a result of the element-wise product operation; and obtain data based on the convolution result.

As one or more non-transitory computer readable medium storing one or more instructions according to an additional aspect of the present disclosure, the one or more instructions may be executed by one or more processors and control an apparatus for performing wireless charging to: perform a first optical Fourier transform on a spatial domain image; perform a second optical Fourier transform on a spatial domain kernel; perform an element-wise product operation between a result of the first optical Fourier transform and a result of the second optical Fourier transform; calculate a convolution result by performing a third optical Fourier transform on a result of the element-wise product operation; and obtain data based on the convolution result.

In various aspects of the present disclosure, the element-wise product operation may be performed by an opto-optical modulator.

In addition, in various aspects of the present disclosure, a wavelength of a control beam associated with the spatial domain kernel and a wavelength of a signal beam associated with the spatial domain image may be selected based on modulation characteristics of the opto-optical modulator.

In addition, in various aspects of the present disclosure, in a case that the wavelength of the control beam and the wavelength of the signal beam are different, the first optical Fourier transform may be performed by a first lens, and the second optical Fourier transform may be performed by a second lens.

In addition, in various aspects of the present disclosure, a focal length of the first lens may be selected based on the wavelength of the signal beam and a dimension of a Fourier domain, and a focal length of the second lens may be selected based on the wavelength of the control beam and a dimension of a Fourier domain.

In addition, in various aspects of the present disclosure, in a case that the wavelength of the control beam and the wavelength of the signal beam are the same, the first optical Fourier transform and the second Fourier transform may be performed by a same lens.

In addition, s aspects of the present disclosure, the spatial domain image may correspond to a function generated by applying spatial light intensity modulation to a signal beam, and the spatial domain kernel may correspond to a function generated by applying spatial light intensity modulation to a control beam.

In addition, in various aspects of the present disclosure, the data may be obtained based on measurements by a camera that receives the convolution result as input.

In addition, in various aspects of the present disclosure, the control beam associated with the spatial domain kernel may be blocked from being input to the camera using an element capable of emitting light.

According to the present disclosure, a method and apparatus for performing spatial domain-based optical convolution calculation may be provided.

According to the present disclosure, a method and apparatus for optically performing a convolution operation of a spatial domain image and a spatial domain kernel by optically Fourier transforming the spatial domain kernel and performing element product operation using an opto-optical modulator may be provided.

According to the present disclosure, for spatial domain-based optical convolution operation, it has the advantage of increasing energy efficiency and realizing fast calculation speed, by processing the Fourier transform process that had to be performed in an electronic computer optically.

Effects achievable by the present disclosure are not limited to the above-described effects, and other effects which are not described herein may be clearly understood by those skilled in the pertinent art from the following description.

### BRIEF DESCRIPTION OF THE DRAWINGS

FIG. 1 illustrates the operation structure of an existing spatial domain kernel-based optical convolution operator.

FIG. 2 illustrates the operation structure of an existing Fourier domain kernel-based optical convolution operator.

FIG. 3 illustrates the operation structure of a spatial domain kernel-based optical convolution operator according to an embodiment of the present disclosure.

FIG. 4 illustrates the optical structure of a spatial domain-based optical convolution operator according to an embodiment of the present disclosure.

FIG. 5 illustrates an example of the structure of a spatial domain-based optical convolution operator considering the wavelengths of signal beam and control beam according to an embodiment of the present disclosure.

FIG. 6 illustrates another example of the structure of a spatial domain-based optical convolution operator considering the wavelengths of signal beam and control beam according to an embodiment of the present disclosure.

FIG. 7 illustrates the structure of a spatial domain-based optical convolution operator considering optical path correction according to an embodiment of the present disclosure.

FIG. 8 illustrates an operational flowchart of a method for performing an optical convolution operation according to an embodiment of the present disclosure.

FIG. 9 is a block diagram illustrating a device according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

In order to meet the demand for a computing system with high processing speed and high energy efficiency, research on convolutional artificial neural networks based on optical convolution operations is in progress.

In this regard, unlike most existing convolutional artificial neural networks that use a spatial domain kernel, the optical convolution calculation device is optically designed to perform calculations using a Fourier domain kernel. In order to apply the spatial domain kernel to the computing device, it is necessary to input/insert the Fourier kernel obtained by Fourier transforming the spatial domain kernel using an electronic computer, etc. into the convolution computing device. This Fourier transform process has the disadvantage of providing additional work to electronic computers, etc., thereby offsetting the advantages of the optical convolution operation device.

Additionally, there are also systems that learn directly using the Fourier domain kernel without using the spatial domain kernel, but, in general, the Fourier domain kernel is tens to hundreds of times larger than the spatial domain kernel, so it cannot be said to be a suitable calculation structure to implement high energy efficiency and fast calculation speed.

Therefore, there is a need for an optical convolution calculation device that may perform convolution calculation by directly applying the spatial domain kernel to the spatial domain image.

In consideration of the above-mentioned points, in the present disclosure, a method and apparatus for optically performing Fourier transform for the spatial domain kernel and optically performing a convolution operation of a spatial domain image (i.e., input image) and a spatial domain kernel, by performing element-wise product calculation using an opto-optical modulator.

The existing optical convolution calculation method using a spatial domain image and a Fourier domain kernel has a disadvantage that offsets the advantages of the optical convolution calculation device, such as high energy efficiency and high calculation speed. In contrast, the optical convolution calculation method and device proposed in this disclosure has the technical effect of minimizing unnecessary calculations and energy consumption that shall be performed by an electronic computer, etc. in an existing optical convolution calculation device.

Generally, the optical convolution operator performs Fourier transform on each of the two functions (e.g., f(x,y), g(x,y)) in order to calculate the convolution of the two functions, and after performing the element-wise product of two Fourier transformed functions (e.g., F(x′,y′), G(x′,y′)), may use the convolution theorem, which states that the result is the same as the inverse-Fourier transform.

The relational expression for this may be expressed as Equation 1 below.

$$f ( x , y ) * g ( x , y ) = {\text{?}}^{- 1} \{ F ( {x}^{′} , {y}^{′} ) \cdot G ( {x}^{′} , {y}^{′} ) \} \qquad [ Equation l ]$$

$$\text{?} \text{indicates text missing or illegible when filed}$$

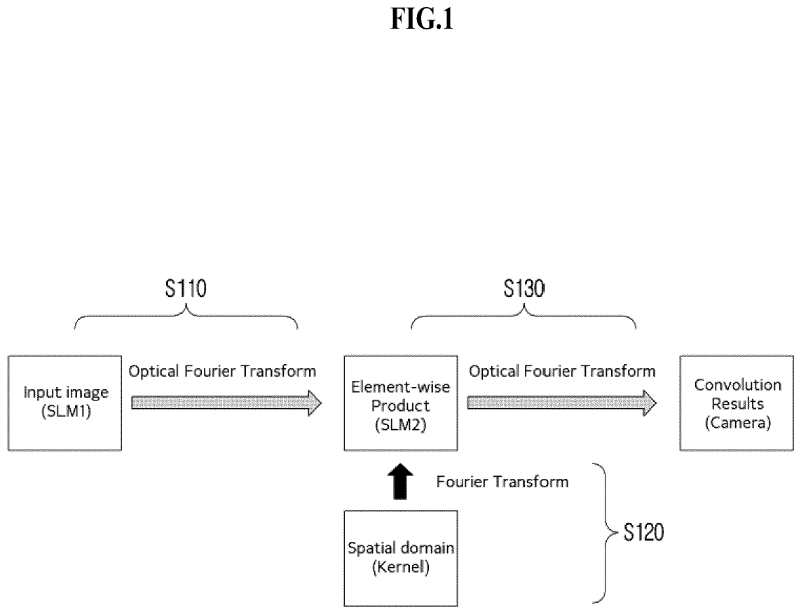

The general operation structure of the optical convolution calculator using Equation 1 may be as shown in FIG. 1.

FIG. 1 illustrates the operation structure of an existing spatial domain kernel-based optical convolution operator.

Referring to FIG. 1, the input image, that is, a spatial domain image (f(x,y)), may be propagated in the form of an amplitude of light by a first spatial light modulator (SLM), and this may be optically Fourier transformed by a lens, etc. (S110).

Additionally, the spatial domain kernel (g(x,y)) may be Fourier transformed using an electronic computer, etc, and this may be input/insert as a function of amplitude into the second SLM for element product (S120).

Afterwards, by the 2nd SLM, the element-wise product between the Fourier transformed image (F(x′,y′)) (i.e., the result in S110) and the Fourier domain kernel (G(x′,y′)) may be performed, and the result may be optically Fourier transformed and output as a convolution result (S130).

Finally, data may be acquired for the corresponding convolution result using a camera or the like.

For this method, since operations such as an electronic computer are required to Fourier transform the spatial domain kernel (g(x,y)), the advantages of the optical convolution calculator, which aims to achieve high energy efficiency and fast calculation speed by minimizing the role of electronic devices, may be offset.

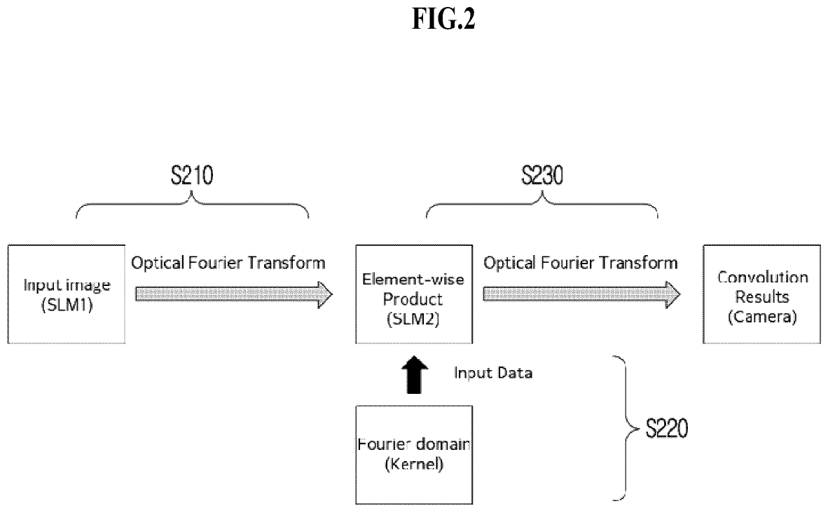

FIG. 2 illustrates the operation structure of an existing Fourier domain kernel-based optical convolution operator.

Referring to FIG. 2, by the first SLM, the input image, that is, the spatial domain image (f(x,y)), may be propagated in the form of light amplitude, and this may be optically Fourier transformed by a lens, etc. (S210).

Additionally, the Fourier domain kernel (G(x′,y′)) obtained by directly learning in the Fourier domain may be input/insert into the second SLM for element product (S220).

Afterwards, by the 2nd SLM, the element-wise product between the Fourier transformed image (F(x′,y′)) (i.e., the result in S210) and the Fourier domain kernel (G(x′,y′)) may be performed, and the result may be optically Fourier transformed and output as a convolution result (S230).

Finally, data may be acquired for the corresponding convolution result using a camera or the like.

In the case of this method, although there is an advantage in not performing Fourier transformation using an electronic computer, etc., the data size of the Fourier domain kernel is tens to hundreds of times larger than that of the spatial domain kernel, which may be disadvantageous in constructing an efficient artificial neural network.

Therefore, there is a need to develop an optical calculation system that directly uses the spatial domain kernel but does not require additional calculations/processing by an electronic computer for Fourier transform.

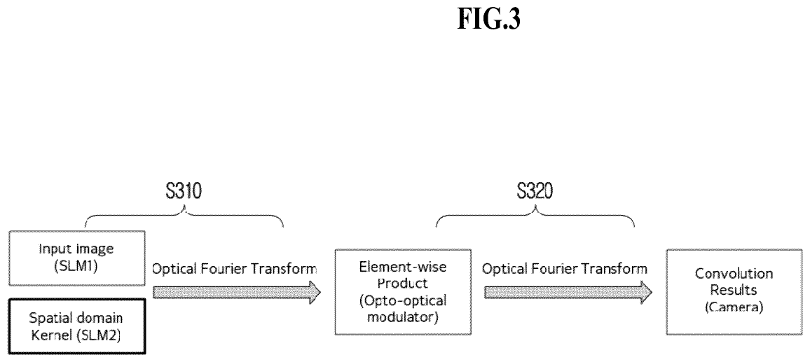

FIG. 3 illustrates the operation structure of a spatial domain kernel-based optical convolution operator according to an embodiment of the present disclosure.

Referring to FIG. 3, unlike the calculation method of the existing convolution operator (e.g., FIGS. 1 and 2), the spatial domain kernel may be optically Fourier transformed and may be applied to the convolution.

By the first SLM, the input image, that is, the spatial domain image (f(x,y)), may be propagated in the form of an amplitude of light, and this may be optically Fourier transformed by a lens or the like. Additionally, by the second SLM, the spatial domain kernel (g(x,y)) may be propagated in the form of an amplitude of light, and this may be optically Fourier transformed by a lens or the like (S310).

Element-by-element product may be performed in the Fourier domain using an opto-optical modulator for the optically Fourier transformed image (F(x′,y′)) and the optically Fourier transformed spatial domain kernel (G(x′,y′)), and the result may be optically Fourier transformed and output as a convolution result (S320).

Finally, data may be acquired for the corresponding convolution result using a camera or the like.

In the case of this method, it is based on a spatial domain kernel with a small data size and processes the Fourier transform optically, so it has the advantage of not requiring computation/processing by an electronic computer for the Fourier transform of the kernel. Because of this, the advantages of an optical convolution computing device with high energy efficiency and high parallelism may be maximized.

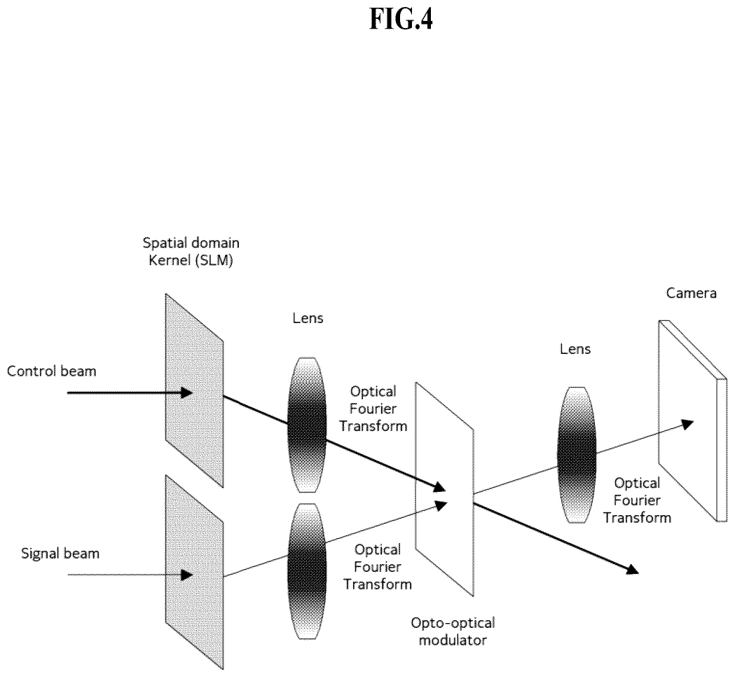

FIG. 4 illustrates the optical structure of a spatial domain-based optical convolution operator according to an embodiment of the present disclosure.

The optical structure shown in FIG. 4 corresponds to the optical structure of a spatial domain optical convolution operator that may directly convolution the spatial domain kernel and the input image, that is, the spatial domain image.

Two parallel beams, referred to as a signal beam and a control beam, may each be incident on a spatial light intensity modulator (SLM).

For example, signal beam is incident on a first SLM, and the first SLM may transmit data with an optical amplitude having a function of a spatial domain image. Additionally, the control beam is incident on the second SLM, and the second SLM may transmit data with an optical amplitude having a function of the spatial domain kernel.

As described above, the two parallel lights whose light intensity has been modulated may each be optically Fourier transformed by a lens.

An opto-optical modulator may be located in the plane where optical Fourier transformed light is generated, and an element-by-element product operation between two optical Fourier transformed functions may be performed through an opto-optical modulator.

In this regard, since the control beam intensity is sufficiently lower than the saturation power, the signal beam transmittance (T(λₛ)) of the opto-optical modulator may be expressed as Equation 2 below if the transmittance can be linearly approximated.

$$T ( {λ}_{s} ) = A \cdot P ( {λ}_{c} ) + {T}_{0} \qquad [ Equation 2 ]$$

In equation 2, λ_{c} and λₛ is represent the wavelength of the control beam and the signal beam, respectively, P(λ_{c}) represents the light intensity of the control beam, A represents the rate of change of T(λₛ) according to P(λ_{c}), T₀ represents the transmittance of signal beam when no control beam is inserted.

In Equation 2, it is assumed that the light intensity of the signal beam does not affect the transmittance of the opto-optical modulator.

For example, when using opto-optical modulators such as smart pixels, the intensity of the signal rarely affects the transmittance, but, the intensity of the signal beam must be low enough to not exhibit saturable absorption characteristics depending on the intensity of the signal beam when using a saturable absorber as an opto-optical modulator. In other words, the transmittance (T(λₛ)) of the opto-optical modulator must be an independent function of the intensity of the signal beam. A saturable absorber, which is one of the opto-optical modulators, has a positive value for A, and an optical limiter has a negative value for A. In smart pixels, A may be either positive or negative depending on the device design.

The wavelengths of the signal beam and the control beam should be selected based on/suited to the modulation characteristics of the opto-optical modulator, the two wavelengths may be the same or different depending on the type of opto-optical modulator. For example, for two-dimensional saturable absorbers such as graphene or smart pixels, it is possible to modulate the transmittance of signal beam with different wavelengths depending on the output of the adjusted light, but the wavelength of the control beam and the output light may need to be designed to be the same if the absorption wavelength band of the saturable absorber is narrow.

When the optical intensity of the signal beam incident on the opto-optical modulator is referred to as Pᵢₙ(λₛ), The optical intensity (Pₒᵤₜ(λₛ)) of the signal beam that has passed (i.e., transmitted) the opto-optical modulator may be expressed as Equation 3 below.

$${P}_{out} ( {λ}_{s} ) = A \cdot P ( {λ}_{c} ) \cdot {P}_{in} ( {λ}_{s} ) + {T}_{0} \cdot {P}_{in} ( {λ}_{s} ) \qquad [ Equation 3 ]$$

The signal beam transmitted or reflected from the opto-optical modulator may pass through the lens again, undergo optical Fourier transformation, and be measured using a camera.

The function of light intensity (Eₒᵤₜ²(x,y)) measured by the camera based on the above-mentioned equation 3 may be expressed as Equation 4 below.

$${E}_{out}^{2} ( x , y ) = A \cdot {[ {\text{?}}^{- 1} \{ F ( {x}^{′} , {y}^{′} ) \cdot G ( {x}^{′} , {y}^{′} ) \} ]}^{2} + {T}_{0} \cdot {[ {\text{?}}^{- 1} \{ F ( {x}^{′} , {y}^{′} ) \} ]}^{2} \qquad [ Equation 4 ]$$

$$\text{?} \text{indicates text missing or illegible when filed}$$

A·[ℑ⁻¹{F(x′,y′)·G(x′,y′)}]² among the finally measured light intensity functions as shown in Equation 4 represents the term for obtaining the result of convolution of two functions. In addition, the term T₀·(ℑ⁻¹{F(x′,y′)})² is an unnecessary calculation result, and only the convolution calculation result may be used through correction to remove the corresponding value. there is. A and T₀ are constants that may be measured in advance during the optical system calibration stage, f(x,y) is a spatial domain image function, so it can be easily corrected.

After performing correction for Equation 4, the convolution result value may be derived by converting to an optical amplitude function, and this may be expressed as Equation 5 below.

$${E}_{c a l} ( x , y ) = {A}^{\frac{1}{2}} \cdot \vert f ( x , y ) * g ( x , y ) \vert \qquad [ Equation 5 ]$$

Hereinafter, a specific example for implementing a spatial domain kernel and an optical convolution operator for spatial domain images will be described.

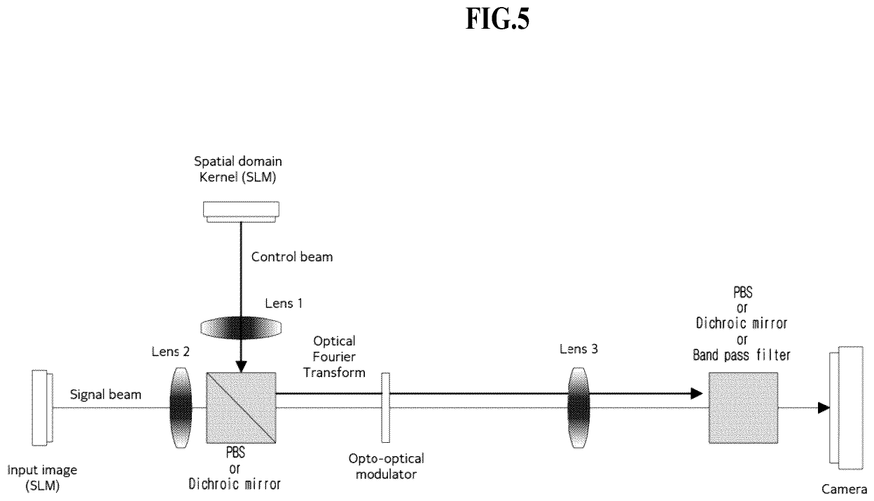

FIG. 5 illustrates an example of the structure of a spatial domain-based optical convolution operator considering the wavelengths of signal beam and control beam according to an embodiment of the present disclosure.

The structure shown in FIG. 5 illustrates the structure of a spatial domain optical convolution operator when the wavelengths of signal beam and control beam are different.

For example, a spatial domain kernel and a spatial domain image may be modulated as a function of optical amplitude, by using two spatial light intensity modulators (SLMs) and parallel light that transmits or reflects the SLMs.

The two modulated functions may be Fourier transformed through each lens (i.e., lens 1, lens 2). Specifically, the function with the spatial domain kernel modulated may be optically Fourier transformed through lens 1, and the function through which the spatial domain image is modulated may be optically Fourier transformed through lens 2.

Additionally, the two light paths may be adjusted to match the direction of the opto-optical modulator, by using devices that can combine light, such as a polarized beam splitter (PBS) or a dichroic mirror. At this time, the focal length of each lens may be selected by considering the two wavelengths of the control beam and the signal beam and the dimension of the Fourier domain.

In this regard, the correlation between the dimension of the Fourier domain, the wavelength, and the lens focal length may be expressed as Equation 6 below.

$${k}_{x} = 2 π \frac{{x}_{i}}{λ {f}_{0}} \qquad [ Equation 6 ]$$

In Equation 6, kₓ represents the spatial frequency, xᵢ represents the coordinates of the Fourier plane, λ represents the wavelength of light, and f₀ represents the focal length of the lens.

Therefore, in order to match the dimensions of the two Fourier transformed functions on the plane during opto-optical modulation, the two wavelengths and the focal length of each lens may be optically designed to follow the relationship shown in Equation 7 below.

$$\frac{{λ}_{s}}{{λ}_{c}} = \frac{{f}_{c}}{{f}_{s}} \qquad [ Equation 7 ]$$

In equation 7, λ_{c} represents the wavelength of the control beam, λₛ represents the wavelength of the signal beam, f_{c} represents the focal length of the lens (i.e., lens 1) that Fourier transforms the control beam, fₛ represents the focal length of the lens (i.e., lens 2) that performs Fourier transform on the signal beam.

Regarding Fourier transformed spatial domain kernel and spatial domain image, an element-wise product operation may be performed by an optical-optical modulator, the signal beam may be again subjected to (optical) Fourier transform by the lens (i.e., lens 3), and the final calculation result may be measured using a camera.

In this regard, a convolution operation result may be obtained by removing the second term in Equation 3 described above from the measured light intensity and converting the measured light intensity value into an optical amplitude function. At this time, the control beam may be prevented from entering the camera by using a polarizing beam splitter, a dichroic mirror, or a band pass filter.

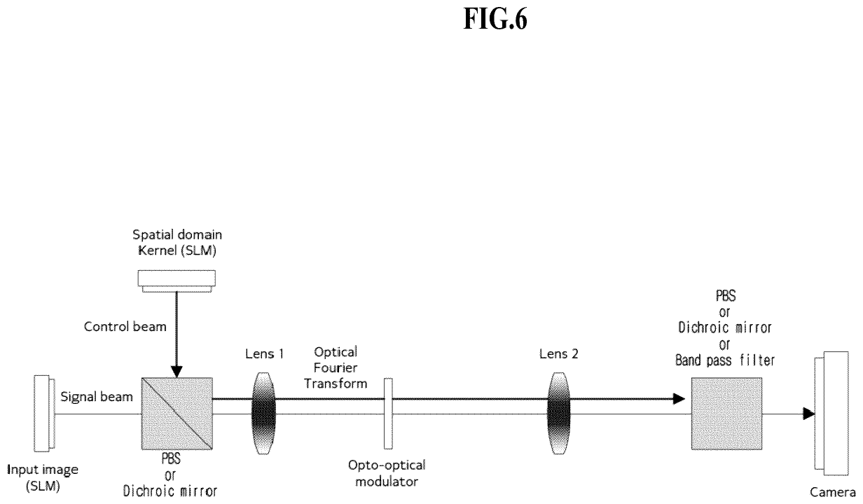

FIG. 6 illustrates another example of the structure of a spatial domain-based optical convolution operator considering the wavelengths of signal beam and control beam according to an embodiment of the present disclosure.

The structure shown in FIG. 6 illustrates the structure of a spatial domain optical convolution operator in the case where the wavelengths of the signal beam and the control beam are the same.

Referring to FIG. 6, for spatial domain images and spatial domain kernels, the two light paths may be adjusted to match the direction of the opto-optical modulator, by using devices that can combine light, such as polarizing beam splitters (PBS) or dichroic mirrors.

Then, by lens 1, the spatial domain kernel and the spatial domain image may be optically Fourier transformed simultaneously.

Regarding Fourier transformed spatial domain kernel and spatial domain image, an element-wise product operation may be performed by an optical-optical modulator, the signal beam may be again subjected to (optical) Fourier transform by the lens (i.e., lens 2), and the final calculation result may be measured using a camera.

In this regard, a convolution operation result may be obtained by removing the second term in Equation 3 described above from the measured light intensity and converting the measured light intensity value into an optical amplitude function. At this time, the control beam may be prevented from entering the camera by using a polarizing beam splitter, a dichroic mirror, or a band pass filter.

Regarding FIGS. 5 and 6 described above, spatial light intensity modulator (SLM) that can be used in an optical convolution calculator may correspond to liquid crystal, digital micro-mirror device (DMD), etc.

If the incident light is transmitted or reflected and then proceeds perpendicular to the plane where the SLM is located, the optical convolution calculator may be designed to have the same structure as the above-described FIG. 5 or FIG. 6.

In contrast, if light travels at a certain angle rather than perpendicular to the SLM plane due to diffraction (e.g., if the SLM of the optical convolution calculator is DMD-based), corrections to the optical path may be required.

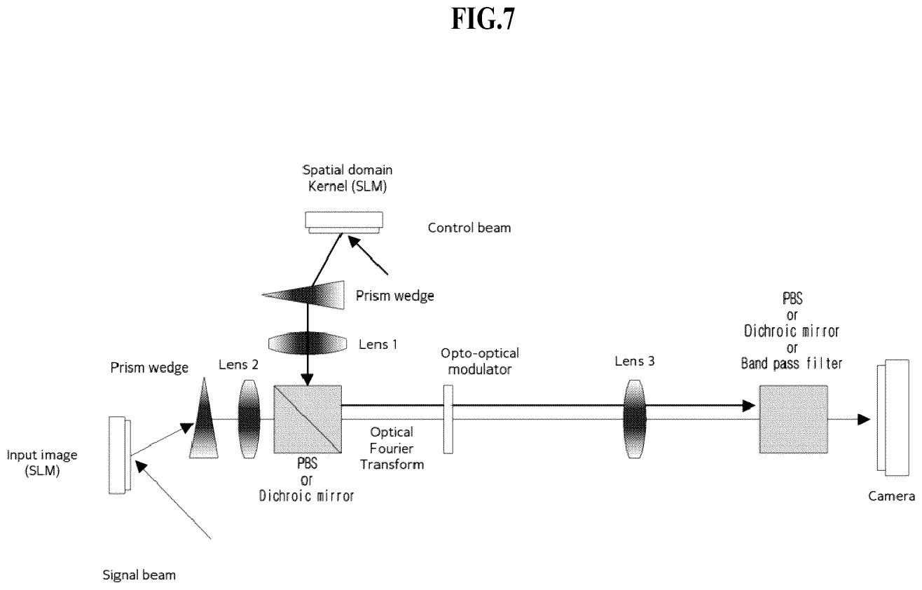

FIG. 7 illustrates the structure of a spatial domain-based optical convolution operator considering optical path correction according to an embodiment of the present disclosure.

Referring to FIG. 7, regarding control beam and signal beam that are incident at a certain angle rather than perpendicular to the SLM plane, optical path correction through prism wedge may be performed.

Through this, the control beam associated with the spatial domain kernel and the signal beam associated with the spatial domain image may be incident perpendicularly to each lens.

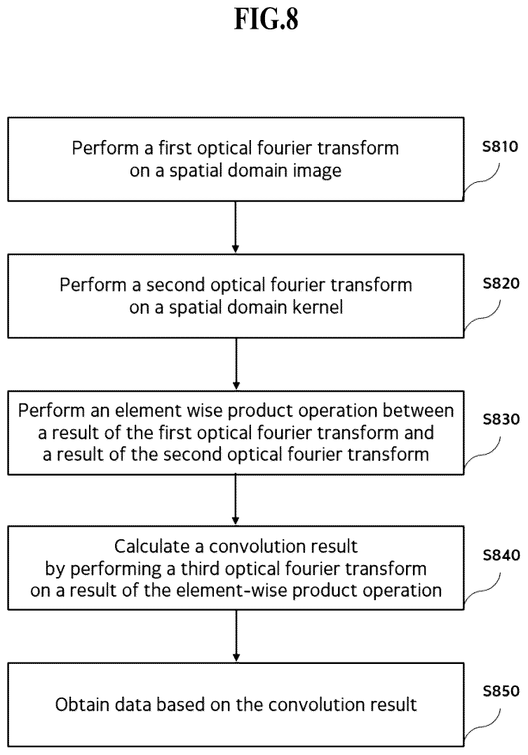

FIG. 8 illustrates an operational flowchart of a method for performing an optical convolution operation according to an embodiment of the present disclosure.

Referring to FIG. 8, the optical convolution calculation device may perform a first optical Fourier transform on a spatial domain image (S810).

Additionally, the optical convolution operation device may perform a second optical Fourier transform on a spatial domain kernel (S820).

For example, the spatial domain image may be based on a function generated by applying spatial light intensity modulation to the signal beam, and the spatial domain kernel may be based on a function generated by applying spatial light intensity modulation to a control beam. That is, each spatial light intensity modulator (SLM) may modulate a spatial domain image or spatial domain kernel as a function of optical amplitude using signal beam or parallel light.

Thereafter, the optical convolution calculation device may perform an element-wise product operation between the result of the first optical Fourier transform and the result of the second optical Fourier transform (S830).

For example, the element-wise product operation may be performed by an opto-optical modulator.

The optical convolution calculation device may performs a third optical Fourier transform on the result of the above-described element-wise product operation to calculate a convolution result (S840), and data may be obtained based on the corresponding convolution result (S850).

For example, the data may be obtained based on measurement by a camera that receives the convolution result as an input. In this regard, the control beam associated with the spatial domain kernel may be blocked from being input to the camera using an element capable of emitting light.

Regarding the foregoing procedure, the wavelength of the control light/beam associated with the spatial domain kernel and the wavelength of the signal light/beam associated with the spatial domain image may be selected based on the modulation characteristics of the opto-optical modulator.

At this time, when the wavelength of the control light/beam and the wavelength of the signal light/beam are different, the first optical Fourier transform may be performed by a first lens, and the second optical Fourier transform may be performed by a second lens. Here, the focal length of the first lens may be selected based on the wavelength of the signal light/beam and the dimension of the Fourier domain, and the focal length of the second lens may be selected based on the wavelength of the control light/beam and the dimension of the Fourier domain.

In contrast, when the wavelength of the control light/beam and the wavelength of the signal light/beam are the same, the first optical Fourier transform and the second optical Fourier transform may be performed by the same lens.

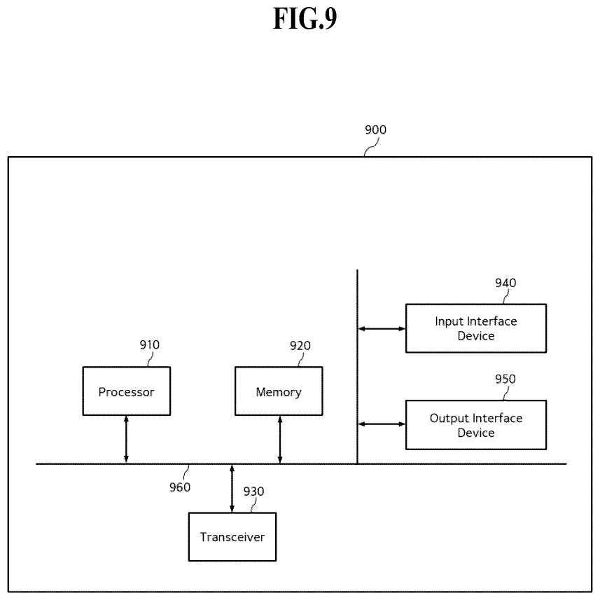

FIG. 9 is a block diagram illustrating an apparatus according to an embodiment of the present disclosure.

Referring to FIG. 9, device 900 may represent a device that implements the method for performing spatial domain-based optical convolution operation described in the present disclosure.

The device 900 may include at least one of a processor 910, a memory 920, a transceiver 930, an input interface device 940, and an output interface device 950. Each of the components may be connected by a common bus 960 to communicate with each other. In addition, each of the components may be connected through a separate interface or a separate bus centering on the processor 910 instead of the common bus 960.

The processor 910 may be implemented in various types such as an application processor (AP), a central processing unit (CPU), a graphic processing unit (GPU), etc., and may be any semiconductor device that executes a command stored in the memory 920. The processor 910 may execute a program command stored in the memory 920. The processor 910 may be configured to implement the method of performing the spatial domain-based optical convolution operation described based on FIGS. 1 to 8 described above.

And/or, the processor 910 may store a program command for implementing at least one function for the corresponding modules in the memory 920 and may control the operation described based on FIGS. 1 to 8 to be performed.

The memory 920 may include various types of volatile or non-volatile storage media. For example, the memory 920 may include read-only memory (ROM) and random access memory (RAM). In an embodiment of the present disclosure, the memory 920 may be located inside or outside the processor 910, and the memory 920 may be connected to the processor 910 through various known means.

The transceiver 930 may perform a function of transmitting and receiving data processed/to be processed by the processor 910 with an external device and/or an external system.

The input interface device 940 is configured to provide data to the processor 910.

The output interface device 950 is configured to output data from the processor 910.

As described above in the present disclosure, the optical convolution calculator has the advantage of increasing energy efficiency and computation speed by calculating the convolution, which accounts for a large proportion of the total calculation amount of the convolutional artificial neural network, using an optical calculator.

However, because the conventional optical convolution calculator shall use a Fourier domain kernel, the number of learning variables for the artificial neural network increases, or an additional Fourier transform operation shall be performed using an electronic computer. This may offset the advantages of the optical convolution calculator, such as high energy efficiency and fast calculation speed.

In contrast, the optical convolution operation device according to the present disclosure is a system that optically processes both the spatial domain kernel and the convolution of the spatial domain image, by optically Fourier transforming both the spatial domain kernel and the spatial domain image, and performing element product operation using an opto-optical modulator. In this case, by processing the Fourier transform process that had to be performed in an electronic computer optically, energy efficiency can be increased and fast calculation speed can be achieved. Additionally, for the optical convolution operation device according to the present disclosure, the advantages can be maximized by performing calculations in real time without using additional energy for element product calculations, when applying a passive opto-optical modulator that does not require a separate power supply.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, it is intended that this disclosure embrace all other substitutions, modifications and variations belong within the scope of the following claims.

What is claimed is:

1. A method of performing a convolution operation, the method comprising:
performing a first optical Fourier transform on a spatial domain image;
performing a second optical Fourier transform on a spatial domain kernel;
performing an element-wise product operation between a result of the first optical Fourier transform and a result of the second optical Fourier transform;
calculating a convolution result by performing a third optical Fourier transform on a result of the element-wise product operation; and
obtaining data based on the convolution result.

2. The method of claim 1,
wherein the element-wise product operation is performed by an opto-optical modulator.

3. The method of claim 2,
wherein a wavelength of a control beam associated with the spatial domain kernel and a wavelength of a signal beam associated with the spatial domain image are selected based on modulation characteristics of the opto-optical modulator.

4. The method of claim 3,
wherein, in a case that the wavelength of the control beam and the wavelength of the signal beam are different, the first optical Fourier transform is performed by a first lens, and the second optical Fourier transform is performed by a second lens.

5. The method of claim 4,
wherein a focal length of the first lens is selected based on the wavelength of the signal beam and a dimension of a Fourier domain, and
wherein a focal length of the second lens is selected based on the wavelength of the control beam and a dimension of a Fourier domain.

6. The method of claim 3,
wherein, in a case that the wavelength of the control beam and the wavelength of the signal beam are the same, the first optical Fourier transform and the second optical Fourier transform are performed by a same lens.

7. The method of claim 1,
wherein the spatial domain image corresponds to a function generated by applying spatial light intensity modulation to a signal beam, and
wherein the spatial domain kernel corresponds to a function generated by applying spatial light intensity modulation to a control beam.

8. The method of claim 1,
wherein the data is obtained based on measurements by a camera that receives the convolution result as input.

9. The method of claim 8,
wherein the control beam associated with the spatial domain kernel is blocked from being input to the camera using an element capable of emitting light.

10. An apparatus for performing wireless charging, the apparatus comprising:
a processor and a memory,
wherein the processor is configured to:
perform a first optical Fourier transform on a spatial domain image;
perform a second optical Fourier transform on a spatial domain kernel;
perform an element-wise product operation between a result of the first optical Fourier transform and a result of the second optical Fourier transform;
calculate a convolution result by performing a third optical Fourier transform on a result of the element-wise product operation; and
obtain data based on the convolution result.

11. The apparatus of claim 10,
wherein the element-wise product operation is performed by an opto-optical modulator.

12. The apparatus of claim 11,
wherein a wavelength of a control beam associated with the spatial domain kernel and a wavelength of a signal beam associated with the spatial domain image are selected based on modulation characteristics of the opto-optical modulator.

13. The apparatus of claim 12,
wherein, in a case that the wavelength of the control beam and the wavelength of the signal beam are different, the first optical Fourier transform is performed by a first lens, and the second optical Fourier transform is performed by a second lens.

14. The apparatus of claim 13,
wherein a focal length of the first lens is selected based on the wavelength of the signal beam and a dimension of a Fourier domain, and
wherein a focal length of the second lens is selected based on the wavelength of the control beam and a dimension of a Fourier domain.

15. The apparatus of claim 12,
wherein, in a case that the wavelength of the control beam and the wavelength of the signal beam are the same, the first optical Fourier transform and the second optical Fourier transform are performed by a same lens.

16. The apparatus of claim 10,
wherein the spatial domain image corresponds to a function generated by applying spatial light intensity modulation to a signal beam, and
wherein the spatial domain kernel corresponds to a function generated by applying spatial light intensity modulation to a control beam.

17. The apparatus of claim 10,
wherein the data is obtained based on measurements by a camera that receives the convolution result as input.

18. The apparatus of claim 17,
wherein the control beam associated with the spatial domain kernel is blocked from being input to the camera using an element capable of emitting light.

19. One or more non-transitory computer readable medium storing one or more instructions,
wherein the one or more instructions are executed by one or more processors and control an apparatus for performing wireless charging to:
perform a first optical Fourier transform on a spatial domain image;
perform a second optical Fourier transform on a spatial domain kernel;
perform an element-wise product operation between a result of the first optical Fourier transform and a result of the second optical Fourier transform;
calculate a convolution result by performing a third optical Fourier transform on a result of the element-wise product operation; and
obtain data based on the convolution result.

20. The computer readable medium of claim 19,
wherein the spatial domain image corresponds to a function generated by applying spatial light intensity modulation to a signal beam, and
wherein the spatial domain kernel corresponds to a function generated by applying spatial light intensity modulation to a control beam.
